(19) United States
(12) Patent Application Publication
(10) Pub. No.: US 2024/0107273 A1
(43) Pub. Date: Mar. 28, 2024

(54) SYSTEMS AND METHODS FOR WIRELESS DELIVERY OF REAL-TIME REACTIONARY DEVICE DATA

(71) Applicant: MIXHalo Corp., San Francisco, CA (US)

(72) Inventors: Christopher Rocco Levitas, San Francisco, CA (US); Jeffrey Thomas Miller, San Diego, CA (US); Daniel Timothy Costantini, San Francisco, CA (US); Esther Boram Lee, San Francisco, CA (US)

(21) Appl. No.: 18/368,627

(22) Filed: Sep. 15, 2023

Related U.S. Application Data
(60) Provisional application No. 63/410,443, filed on Sep. 27, 2022.

(51) Int. Cl. H04W 4/029

(52) U.S. Cl. CPC H04W 4/029

(57) ABSTRACT

A method for delivery of real-time reactionary device data based on location data of a mobile computing device at a live event includes receiving a data representation of a live audio signal corresponding to the live event via a wireless network. The method also includes processing the data representation of the live audio signal into a live audio stream and determining a location of the mobile computing device with respect to a reference point or a main stage at the live event based on location data. The method also includes determining reactionary device data based on the location of the mobile computing device at the live event and initiating a device reaction based on the reactionary device data.

### RELATED APPLICATION(S)

This application claims priority to U.S. Provisional Patent Application No. 63/410,443, filed Sep. 27, 2022, the entirety of which is incorporated herein by reference.

### FIELD OF THE INVENTION

This invention relates generally to the field of real-time delivery of data, such as audio and visuals, over wireless networks. More specifically, the invention relates to systems and methods for real-time delivery of reactionary device data over wireless networks.

### BACKGROUND

Attendees of live events are often given interactive wristbands that light up and change colors throughout the event. These interactive wristbands are often preprogrammed based on static references (e.g., percentages of total devices to be designed one way or another, or distributed alongside preset choreography) or remote controlled. However, purchasing, distributing, and controlling these wristbands can be costly and time-consuming for the venue, especially because attendees often do not return the wristbands to the venue at the end of the event. On the other hand, most attendees bring their own mobile device to the venue. Therefore, there is a need for systems and methods that can leverage the capabilities of attendees' mobile devices to supplant interactive wristbands at live events.

### SUMMARY

The present invention includes systems and methods for delivery of real-time reactionary device data based on location data. For example, the present invention includes systems and methods for determining a location or a dynamic location of a mobile computing device with respect to a reference point at a live event, such as a main stage at the live event, based on location data. The present invention also includes systems and methods for determining reactionary device data based on the location of the mobile computing device and initiating a device reaction based on the reactionary device data.

In one aspect, the invention includes a computerized method for delivery of real-time reactionary device data based on location data of a mobile computing device at a live event. The computerized method includes receiving a data representation of a live audio signal corresponding to the live event via a wireless network. The computerized method also includes processing the data representation of the live audio signal into a live audio stream. The computerized method also includes determining a location of the mobile computing device with respect to a reference point at a live event, such as a main stage at the live event, based on location data. The computerized method also includes determining reactionary device data based on the location of the mobile computing device. The computerized method also includes initiating a device reaction based on the reactionary device data.

In some embodiments, the computerized method further includes receiving the data representation of the live audio signal corresponding to the live event from an audio server computing device via the wireless network. In some embodiments, the computerized method further includes receiving the location data from an audio server computing device via the wireless network.

In some embodiments, the computerized method further includes determining the location data based on audio captured by a microphone of the mobile computing device. For example, in some embodiments, the location data includes a distance from the reference point or the main stage at the live event.

In other embodiments, the computerized method further includes receiving the location data from a second mobile computing device at the live event. In some embodiments, the computerized method further includes receiving the location data from an access point at the live event. For example, in some embodiments, the computerized method further includes receiving the location data from a Wi-Fi access point at the live event.

In some embodiments, the device reaction corresponds to an illumination of a light source of the mobile computing device at the live event. In other embodiments, the device reaction corresponds to an illumination of a display of the mobile computing device at the live event.

In some embodiments, the device reaction corresponds to a vibration of the mobile computing device at the live event. In other embodiments, the device reaction corresponds to a notification on a display of the mobile computing device at the live event.

In another aspect, the invention includes a system for delivery of real-time reactionary device data based on location data. The system includes a mobile computing device at a live event communicatively coupled to an audio server computing device over a network. The mobile computing device is configured to receive a data representation of a live audio signal corresponding to the live event via the wireless network. The mobile computing device is also configured to process the data representation of the live audio signal into a live audio stream. The mobile computing device is also configured to determine a location of the mobile computing device with respect to a reference point at a live event, such as a main stage at the live event, based on location data. The mobile computing device is also configured to determine reactionary device data based on the location of the mobile computing device. The mobile computing device is also configured to initiate a device reaction based on the reactionary device data.

In some embodiments, the mobile computing device at the live event is further configured to receive the data representation of the live audio signal corresponding to the live event from the audio server computing device via the wireless network. In some embodiments, the mobile computing device at the live event is further configured to receive the location data from an audio server computing device via the wireless network.

In some embodiments, the mobile computing device at the live event is configured to determine the location data based on audio captured by a microphone of the mobile computing device. For example, in some embodiments, the location data includes a distance from the reference point or the main stage at the live event.

In some embodiments, the mobile computing device at the live event is configured to receive the location data from a second mobile computing device at the live event. In other embodiments, the mobile computing device at the live event is configured to receive the location data from an access point at the live event. For example, in some embodiments, the mobile computing device at the live event is configured to receive the location data from a Wi-Fi access point at the live event.

In some embodiments, the device reaction corresponds to an illumination of a light source of the mobile computing device at the live event. In other embodiments, the device reaction corresponds to an illumination of a display of the mobile computing device at the live event.

In some embodiments, the device reaction corresponds to a vibration of the mobile computing device at the live event. In other embodiments, the device reaction corresponds to a notification on a display of the mobile computing device at the live event.

These and other aspects of the invention will be more readily understood from the following descriptions of the invention, when taken in conjunction with the accompanying drawings and claims.

### BRIEF DESCRIPTION OF THE DRAWINGS

FIG. 1 is a schematic diagram of a system architecture for delivery of real-time reactionary device data based on location data of a mobile computing device at a live event, according to an illustrative embodiment of the invention.

FIG. 2 is a detailed schematic diagram of a system architecture for delivery of real-time reactionary device data based on location data of a mobile computing device at a live event, according to an illustrative embodiment of the invention.

FIG. 3 is a schematic flow diagram illustrating delivery of real-time reactionary device data based on location data using the system architecture of FIGS. 1 and 2, according to an illustrative embodiment of the invention.

### DETAILED DESCRIPTION

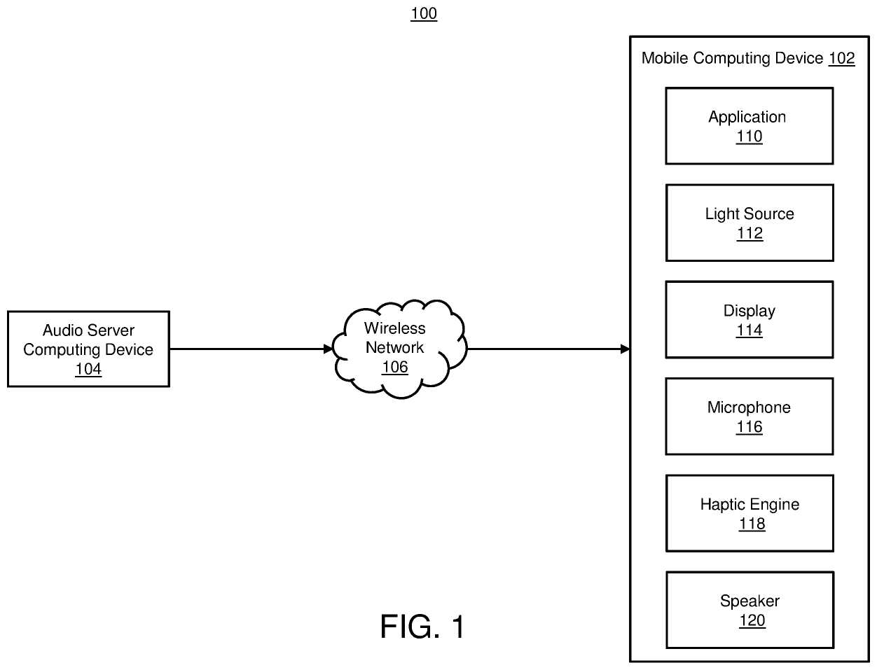

FIG. 1 is a schematic diagram of a system architecture 100 for delivery of real-time reactionary device data based on location data using a mobile computing device, according to an illustrative embodiment of the invention. System 100 includes a mobile computing device 102 communicatively coupled to an audio server computing device 104 over a wireless network 106. Mobile computing device 102 includes an application 110, a light source 112, a display 114, a microphone 116, a haptic engine 118, and a speaker 120. In some embodiments, the audio server computing device 104 is communicatively coupled to an audio interface (not shown).

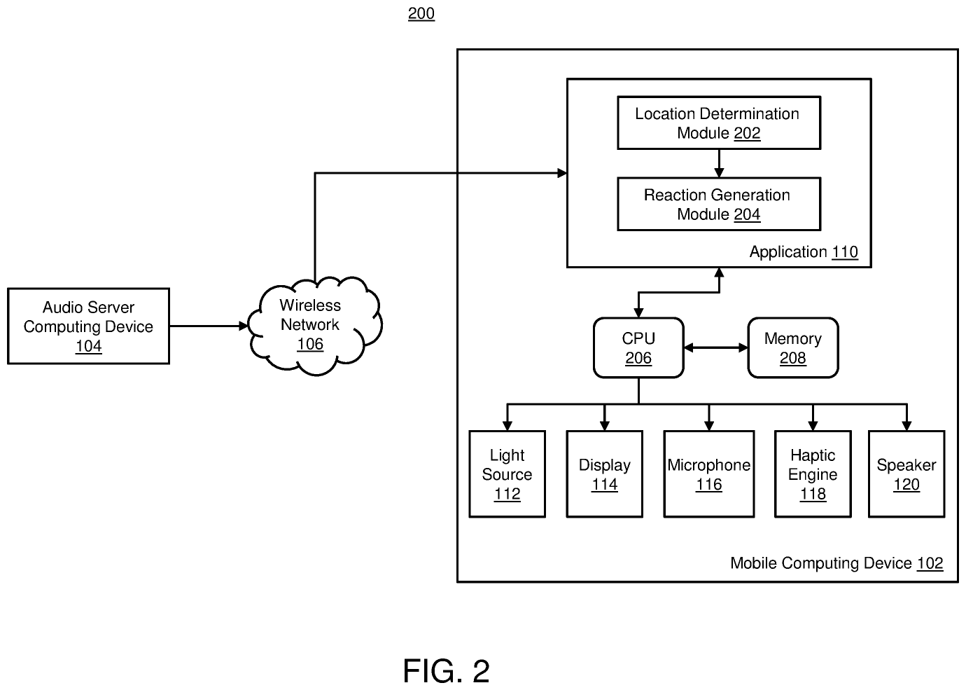

FIG. 2 is a detailed schematic diagram of a system architecture 200 for generating real-time reactionary device data based on live audio data, according to an illustrative embodiment of the invention. In addition to the components described above with respect to FIG. 1, application 110 includes a location determination module 202 that is configured to receive a data representation of a live audio signal corresponding to the live event from audio server computing device 104 via wireless network 106 and process the data representation of the live audio signal as described herein to determine a location of the mobile computing device 202 with respect to a reference point (e.g., a main stage) at the live event. Application 110 also includes a reaction generation module 204 that is configured to generate reactionary device data based the determined location and initiate a device reaction based on the reactionary device data. FIG. 2 also illustrates the CPU 206 and memory 208 of mobile computing device 102. Generally, modules 202, 204 are specialized sets of computer software instructions which execute on one or more processors of server computing device 106 (e.g., CPU 206). In some embodiments, modules 202, 204 can specify designated memory locations and/or registers for executing the specialized computer software instructions.

Exemplary mobile computing devices 102 include, but are not limited to, tablets and smartphones, such as Apple® iPhone®, iPad® and other iOS®-based devices, and Samsung® Galaxy®, Galaxy Tab™ and other Android™-based devices. It should be appreciated that other types of computing devices capable of connecting to and/or interacting with the components of system 100 can be used without departing from the scope of invention. Although FIG. 1 depicts a single mobile computing device 102, it should be appreciated that system 100 can include a plurality of client computing devices.

Mobile computing device 102 is configured to receive instructions from application 110 in order to wirelessly capture real-time audio (and, in some embodiments, video) at a live event. For example, mobile computing device 102 is configured to receive a data representation of a live audio signal corresponding to the live event via wireless network 106. Mobile computing device 102 is also configured to process the data representation of the live audio signal into a live audio stream. In some embodiments, the mobile computing device 102 is configured to receive the data representation of the live audio signal corresponding to the live event from the audio server computing device 104 via the wireless network 106. In some embodiments, audio server computing device 104 is coupled to an audio source at the live event (e.g., a soundboard that is capturing the live audio).

An exemplary application 110 can be an app downloaded to and installed on the mobile computing device 102 via, e.g., the Apple® App Store or the Google® Play Store. The user can launch application 110 on the mobile computing device 102 and interact with one or more user interface elements displayed by the application 110 on a screen of the mobile computing device 102 to begin receiving the data representation of the live audio signal.

Mobile computing device 102 is also configured to determine a location of the mobile computing device 102 with respect to a reference point at a live event, such as a main stage at the live event, based on location data. In some embodiments, the mobile computing device 102 is configured to determine the location data based on audio captured by a microphone 116 of the mobile computing device 102. For example, in some embodiments, the location data includes a distance from the reference point or the main stage at the live event. In some embodiments, the mobile computing device 102 is configured to receive the location data from the audio server computing device 104 via the wireless network 106.

In some embodiments, the mobile computing device 102 is configured to determine a location of the mobile computing device 102 with respect to a reference point at the live event by time aligning using audio captured at the listener's location (e.g., via mobile computing device 102) paired with a reference stream (e.g., the live audio signal received via the wireless network 106). In one example, the time aligning is based upon time delay estimation (TDE) using a cross-correlation (CC) formula. Input parameters for the TDE (which uses a CC formula) may include:
Cycle: A cycle consists of a length of a stream recording and mic recording from a computing device (e.g., a mobile device) mic or headphone mic. The length of the cycle is defined by the variables below.
Analysis Window Size: The size (e.g., in milliseconds) of the window where the two clips are compared. This window size may be set variably.
Analysis Step Size: The length (e.g., in milliseconds) the analysis window is advanced after an iteration of analysis done by the CC formula. The Step Size may be set variably.
Steps per Cycle: The number of steps of Step Size length that the real time audio streaming platform's TDE will consider when estimating the delay between the two audio clips in the present Cycle. The Steps per Cycle may be set variably.
Partial Steps: The act of breaking the Steps per Cycle analysis into smaller chunks to decrease redundant calculations.
Max Delay: The maximum distance (e.g., in milliseconds) the two samples could be offset from each other. The Max Delay may be set variably.
Min Delay: The minimum distance (e.g., in milliseconds) the two samples could be offset from each other. The Min Delay may be set variably.
Interval: Used to determine how frequently the TDE process runs. The Interval parameter is used to reduce impact on the device.

In some implementations, the time complexity of the cross-correlation may be related linearly to two input variables: max delay and analysis window.

O(n)=O(max delay*analysis window)=O(mw)

The CC function also may be repeated for each analysis step in the sample.

O(n)=O(mw)*O(cycle length/analysis step)=O(mwL/s)

In some embodiments, an audio sample of the live audio signal received from the audio server computing device 104 and an audio sample captured by one or more microphones of the mobile computing device 102 are analyzed. The analysis includes defining an Analysis Window. In some implementations, the Analysis Step Size is then set to half the Analysis Window for each iteration. On each iteration, the Analysis Window is passed to the CC formula which produces a delay estimate value. This delay value can be bounded by the Max Delay variable in order to increase the speed of the CC formula (which is done by bounding how many calculations need to be done per Step Size). The Window is then advanced by the length specified by the analysis Step Size (e.g., half of the analysis window) in the next iteration and the delay is calculated again. This process continues until Cycle or Sample has been completely analyzed. Additional detail regarding dynamic latency and time aligning using cross-correlation is described in U.S. patent application Ser. No. 17/864,720, titled “Dynamic Latency Estimation for Audio Streams,” filed on Jul. 14, 2022, the entirety of which is incorporated herein by reference. In such embodiments, once the mobile computing device 102 performs the time aligning step, the device 102 can transmit the estimated dynamic latency (which can comprise the location data) to audio server computing device 104, which determines a distance of the listener's mobile computing device 102 from the reference point (e.g., the stage where the live audio signal is originating) based upon the estimated dynamic latency. In some embodiments, the mobile computing device 102 can locally determine the distance of the mobile computing device 102 from the reference point.

In some embodiments, the mobile computing device 102 is configured to receive the location data from a second mobile computing device at the live event. For example, in some embodiments, the mobile computing device 102 is configured to receive the location data from the second mobile computing device via the wireless network 106 or via Bluetooth®. In other embodiments, the mobile computing device 102 is configured to receive the location data from an access point at the live event. For example, in some embodiments, the mobile computing device 102 is configured to receive the location data from a Wi-Fi™ access point at the live event.

Mobile computing device 102 is also configured to determine reactionary device data based on the location of the mobile computing device 102. In some embodiments, upon determining the location of the mobile computing device 102, the device 102 can generate reactionary device data corresponding to the location. In some embodiments, the reactionary device data comprises programmatic instructions to cause one or more hardware and/or software components of mobile computing device 102 to activate and/or perform a defined function. Exemplary hardware and/or software components of mobile computing device 102 that can be activated or triggered using the reactionary device data include, but are not limited to, a display screen (e.g., display 114), a camera, a camera flash (e.g., light source 112), a haptic module (e.g., haptic engine 118 such as Taptic Engine™ in Apple iPhones®), a microphone, (e.g., microphone 116), a speaker (e.g., speaker 120), or other types of sensory modules or features of mobile computing device 102. In some embodiments, the reactionary device data can cause an external device that is coupled to mobile computing device 102 via a wired or wireless connection (e.g., Bluetooth® headphones) to activate.

Mobile computing device 102 is also configured to initiate a device reaction based on the reactionary device data. As mentioned above, the reactionary device data can comprise programmatic instructions that are received and executed by a processor and/or operating system of mobile computing device 102. Upon generating the reactionary device data, mobile computing device 102 can use the reactionary device data to initiate a device reaction. In some embodiments, one or more attributes of the device reaction are based upon the determined location of the mobile computing device 102 as described above.

For example, in some embodiments, the device reaction corresponds to an illumination of a light source 112 of the mobile computing device 102 at the live event. For example, in some embodiments, the light source 112 of the mobile computing device 102 corresponds to a camera flash of the mobile computing device 102. In other embodiments, the device reaction corresponds to an illumination of a display 114 of the mobile computing device 102 at the live event. In some embodiments, the device reaction corresponds to a notification on a display 114 of the mobile computing device 102 at the live event. In some embodiments, the device reaction corresponds to a vibration of the mobile computing device 102 at the live event.

In some embodiments, one or more characteristics of the device reaction can be based upon the determined location of the mobile computing device 102. For example, devices that are determined to be in a particular location (or range of locations) can initiate a first device reaction, such as illuminating the display of mobile computing device 102 with a specific color. Devices that are determined to be in a different location can initiate a second device reaction, such as illuminating the display of mobile computing device 102 with a different color.

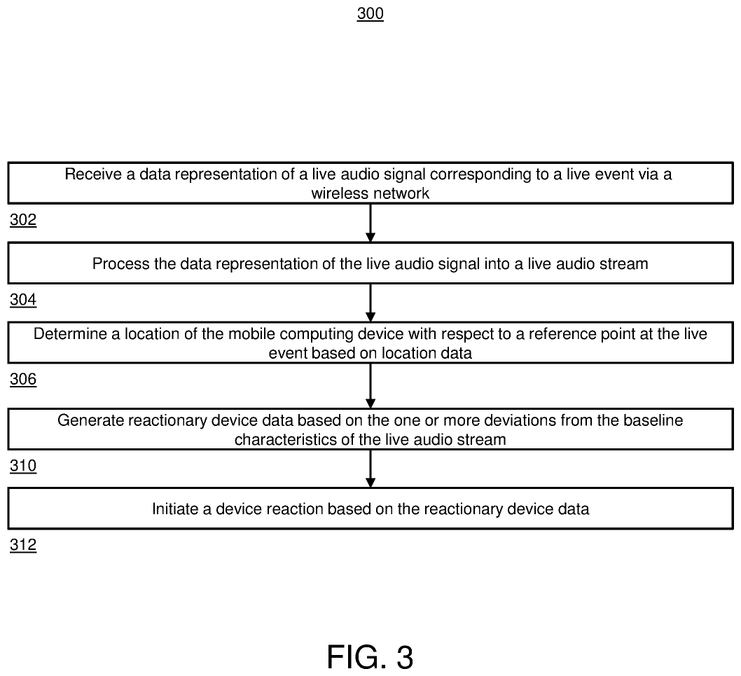

FIG. 3 is a schematic flow diagram of a process 300 for delivery of real-time reactionary device data based on location data at a live event using a mobile computing device 102, according to an illustrative embodiment of the invention. Process 300 begins by receiving, by a mobile computing device 102 at a live event, a data representation of a live audio signal corresponding to the live event via a wireless network 106 at step 302. For example, in some embodiments, the mobile computing device 102 is configured to receive the data representation of the live audio signal corresponding to the live event from an audio server computing device 104 via the wireless network 106.

Process 300 continues by processing, by the mobile computing device 102 at the live event, the data representation of the live audio signal into a live audio stream at step 304. Process 300 continues by determining, by the mobile computing device 102 at the live event, a location of the mobile computing device 102 with respect to a reference point at a live event, such as a main stage at the live event, based on location data at step 306. In some embodiments, the mobile computing device 102 is configured to determine the location data based on audio captured by a microphone 116 of the mobile computing device 102. For example, in some embodiments, the location data includes a distance from the reference point or the main stage at the live event. In some embodiments, the mobile computing device 102 is configured to receive the location data from the audio server computing device 104 via the wireless network 106.

In some embodiments, the mobile computing device 102 is configured to receive the location data from a second mobile computing device at the live event. For example, in some embodiments, the mobile computing device 102 is configured to receive the location data from the second mobile computing device via the wireless network 106 or via Bluetooth®. In other embodiments, the mobile computing device 102 is configured to receive the location data from an access point at the live event. For example, in some embodiments, the mobile computing device 102 is configured to receive the location data from a Wi-Fi™ access point at the live event.

Process 300 continues by generating, by the mobile computing device 102 at the live event, reactionary device data based on the location of the mobile computing device 102 at step 308. Process 300 finishes by initiating, by the mobile computing device 102 at the live event, a device reaction based on the reactionary device data at step 310. For example, in some embodiments, the device reaction corresponds to an illumination of a light source 112 of the mobile computing device 102 at the live event. For example, in some embodiments, the light source 112 of the mobile computing device 102 corresponds to a camera flash of the mobile computing device 102.

In other embodiments, the device reaction corresponds to an illumination of a display 114 of the mobile computing device 102 at the live event. In some embodiments, the device reaction corresponds to a notification on a display 114 of the mobile computing device 102 at the live event. In some embodiments, the device reaction corresponds to a vibration of the mobile computing device 102 at the live event.

The above-described techniques can be implemented in digital and/or analog electronic circuitry, or in computer hardware, firmware, software, or in combinations of them. The implementation can be as a computer program product, i.e., a computer program tangibly embodied in a machine-readable storage device, for execution by, or to control the operation of, a data processing apparatus, e.g., a programmable processor, a computer, and/or multiple computers. A computer program can be written in any form of computer or programming language, including source code, compiled code, interpreted code and/or machine code, and the computer program can be deployed in any form, including as a stand-alone program or as a subroutine, element, or other unit suitable for use in a computing environment. A computer program can be deployed to be executed on one computer or on multiple computers at one or more sites. The computer program can be deployed in a cloud computing environment (e.g., Amazon® AWS, Microsoft® Azure, IBM® Cloud).

Method steps can be performed by one or more processors executing a computer program to perform functions of the invention by operating on input data and/or generating output data. Method steps can also be performed by, and an apparatus can be implemented as, special purpose logic circuitry, e.g., a FPGA (field programmable gate array), a FPAA (field-programmable analog array), a CPLD (complex programmable logic device), a PSoC (Programmable System-on-Chip), ASIP (application-specific instruction-set processor), or an ASIC (application-specific integrated circuit), or the like. Subroutines can refer to portions of the stored computer program and/or the processor, and/or the special circuitry that implement one or more functions.

Processors suitable for the execution of a computer program include, by way of example, special purpose microprocessors specifically programmed with instructions executable to perform the methods described herein, and any one or more processors of any kind of digital or analog computer. Generally, a processor receives instructions and data from a read-only memory or a random-access memory or both. The essential elements of a computer are a processor for executing instructions and one or more memory devices for storing instructions and/or data. Memory devices, such as a cache, can be used to temporarily store data. Memory devices can also be used for long-term data storage. Generally, a computer also includes, or is operatively coupled to receive data from or transfer data to, or both, one or more mass storage devices for storing data, e.g., magnetic, magneto-optical disks, or optical disks. A computer can also be operatively coupled to a communications network in order to receive instructions and/or data from the network and/or to transfer instructions and/or data to the network. Computer-readable storage mediums suitable for embodying computer program instructions and data include all forms of volatile and non-volatile memory, including by way of example semiconductor memory devices, e.g., DRAM, SRAM, EPROM, EEPROM, and flash memory devices; magnetic disks, e.g., internal hard disks or removable disks; magneto-optical disks; and optical disks, e.g., CD, DVD™, HD-DVD™, and Blu-ray™ disks. The processor and the memory can be supplemented by and/or incorporated in special purpose logic circuitry.

To provide for interaction with a user, the above described techniques can be implemented on a computing device in communication with a display device, e.g., a CRT (cathode ray tube), plasma, or LCD (liquid crystal display) monitor, a mobile device display or screen, a holographic device and/or projector, for displaying information to the user and a keyboard and a pointing device, e.g., a mouse, a trackball, a touchpad, or a motion sensor, by which the user can provide input to the computer (e.g., interact with a user interface element). Other kinds of devices can be used to provide for interaction with a user as well; for example, feedback provided to the user can be any form of sensory feedback, e.g., visual feedback, auditory feedback, or tactile feedback; and input from the user can be received in any form, including acoustic, speech, and/or tactile input.

The above-described techniques can be implemented in a distributed computing system that includes a back-end component. The back-end component can, for example, be a data server, a middleware component, and/or an application server. The above-described techniques can be implemented in a distributed computing system that includes a front-end component. The front-end component can, for example, be a client computer having a graphical user interface, a Web browser through which a user can interact with an example implementation, and/or other graphical user interfaces for a transmitting device. The above-described techniques can be implemented in a distributed computing system that includes any combination of such back-end, middleware, or front-end components.

The components of the computing system can be interconnected by transmission medium, which can include any form or medium of digital or analog data communication (e.g., a communication network). Transmission medium can include one or more packet-based networks and/or one or more circuit-based networks in any configuration. Packet-based networks can include, for example, the Internet, a carrier internet protocol (IP) network (e.g., local area network (LAN), wide area network (WAN), campus area network (CAN), metropolitan area network (MAN), home area network (HAN)), a private IP network, an IP private branch exchange (IPBX), a wireless network (e.g., radio access network (RAN), Bluetooth®, near field communications (NFC) network, Wi-Fi™, WiMAX, general packet radio service (GPRS) network, HiperLAN), and/or other packet-based networks. Circuit-based networks can include, for example, the public switched telephone network (PSTN), a legacy private branch exchange (PBX), a wireless network (e.g., RAN, code-division multiple access (CDMA) network, time division multiple access (TDMA) network, global system for mobile communications (GSM) network), and/or other circuit-based networks.

Information transfer over transmission medium can be based on one or more communication protocols. Communication protocols can include, for example, Ethernet protocol, Internet Protocol (IP), Voice over IP (VOIP), a Peer-to-Peer (P2P) protocol, Hypertext Transfer Protocol (HTTP), Session Initiation Protocol (SIP), H.323, Media Gateway Control Protocol (MGCP), Signaling System #7 (SS7), a Global System for Mobile Communications (GSM) protocol, a Push-to-Talk (PTT) protocol, a PTT over Cellular (POC) protocol, Universal Mobile Telecommunications System (UMTS), 3GPP Long Term Evolution (LTE) and/or other communication protocols.

Devices of the computing system can include, for example, a computer, a computer with a browser device, a telephone, an IP phone, a mobile device (e.g., cellular phone, personal digital assistant (PDA) device, smart phone, tablet, laptop computer, electronic mail device), and/or other communication devices. The browser device includes, for example, a computer (e.g., desktop computer and/or laptop computer) with a World Wide Web browser (e.g., Chrome™ from Google, Inc., Microsoft® Edge™ available from Microsoft Corporation, and/or Mozilla® Firefox available from Mozilla Corporation). Mobile computing device include, for example, an iPhone® from Apple Corporation, and/or an Android™-based device. IP phones include, for example, a Cisco® Unified IP Phone 7985G and/or a Cisco® Unified Wireless Phone 7920 available from Cisco Systems, Inc.

The systems and methods described herein can be implemented using supervised learning and/or machine learning algorithms. Supervised learning is the machine learning task of learning a function that maps an input to an output based on example of input-output pairs. It infers a function from labeled training data consisting of a set of training examples. Each example is a pair consisting of an input object and a desired output value. A supervised learning algorithm or machine learning algorithm analyzes the training data and produces an inferred function, which can be used for mapping new examples.

Comprise, include, and/or plural forms of each are open ended and include the listed parts and can include additional parts that are not listed. And/or is open ended and includes one or more of the listed parts and combinations of the listed parts.

While the invention has been particularly shown and described with reference to specific preferred embodiments, it should be understood by those skilled in the art that various changes in form and detail may be made therein without departing from the spirit and scope of the invention as defined by the following claims.

1. A computerized method for delivery of real-time reactionary device data based on location data, the method comprising:
receiving, by a mobile computing device at a live event, a data representation of a live audio signal corresponding to the live event via a wireless network;
processing, by the mobile computing device at the live event, the data representation of the live audio signal into a live audio stream;
determining, by the mobile computing device at the live event, a location of the mobile computing device with respect to a reference point at the live event based on location data;
determining, by the mobile computing device at the live event, reactionary device data based on the location of the mobile computing device; and
initiating, by the mobile computing device at the live event, a device reaction based on the reactionary device data.

2. The method of claim 1, wherein the mobile computing device at the live event is configured to receive the data representation of the live audio signal corresponding to the live event from an audio server computing device via the wireless network.

3. The method of claim 1, wherein the mobile computing device at the live event is configured to determine the location data based on audio captured by a microphone of the mobile computing device.

4. The method of claim 3, wherein the location data comprises a distance from the reference point at the live event.

5. The method of claim 1, wherein the mobile computing device at the live event is configured to receive the location data from a second mobile computing device at the live event.

6. The method of claim 1, wherein the mobile computing device at the live event is configured to receive the location data from an access point at the live event.

7. The method of claim 1, wherein the device reaction corresponds to an illumination of a light source of the mobile computing device at the live event.

8. The method of claim 1, wherein the device reaction corresponds to an illumination of a display of the mobile computing device at the live event.

9. The method of claim 1, wherein the device reaction corresponds to a vibration of the mobile computing device at the live event.

10. The method of claim 1, wherein the device reaction corresponds to a notification on a display of the mobile computing device at the live event.

11. A system for delivery of real-time reactionary device data based on location data, the system comprising:
a mobile computing device at a live event communicatively coupled to an audio server computing device over a network, the mobile computing device at the live event configured to:
receive a data representation of a live audio signal corresponding to the live event via the wireless network;
process the data representation of the live audio signal into a live audio stream;
determine a location of the mobile computing device with respect to a reference point at the live event based on location data;
determine reactionary device data based on the location of the mobile computing device; and
initiate a device reaction based on the reactionary device data.

12. The system of claim 11, wherein the mobile computing device at the live event is configured to receive the data representation of the live audio signal corresponding to the live event from the audio server computing device via the wireless network.

13. The system of claim 11, wherein the mobile computing device at the live event is configured to determine the location data based on audio captured by a microphone of the mobile computing device.

14. The system of claim 13, wherein the location data comprises a distance from the reference point at the live event.

15. The system of claim 11, wherein the mobile computing device at the live event is configured to receive the location data from a second mobile computing device at the live event.

16. The system of claim 11, wherein the mobile computing device at the live event is configured to receive the location data from an access point at the live event.

17. The system of claim 11, wherein the device reaction corresponds to an illumination of a light source of the mobile computing device at the live event.

18. The system of claim 11, wherein the device reaction corresponds to an illumination of a display of the mobile computing device at the live event.

19. The system of claim 11, wherein the device reaction corresponds to a vibration of the mobile computing device at the live event.

20. The system of claim 11, wherein the device reaction corresponds to a notification on a display of the mobile computing device at the live event.
